(19) United States
(12) Patent Application Publication
(10) Pub. No.: US 2026/0086778 A1
(43) Pub. Date: Mar. 26, 2026

(54) CREATING OF AN APP INCLUDING APP CHARACTERISTICS METHOD AND SYSTEM

(71) Applicant: Mendix Technology B.V., Rotterdam (NL)

(72) Inventor: Sean Ryan, Den Haag (NL)

(21) Appl. No.: 18/933,507

(22) Filed: Oct. 31, 2024

Related U.S. Application Data
(60) Provisional application No. 63/699,263, filed on Sep. 26, 2024.

(51) Int. Cl. G06F 8/35

(52) U.S. Cl. CPC G06F 8/35

(57) ABSTRACT

For an improved creation of an app including app characteristics, a computer-implemented method includes: providing an app development UI of an app development platform to a user for developing the app; providing a default program prompt associated with a large language model, wherein the default program prompt includes a first prompt to generate one or more function calls relating to default app characteristics matching received user input; receiving natural language user input indicative of at least one app characteristic of the app; determining the respective app characteristic using the default program prompt, the received user input and the large language model; and developing the app using the respective determined app characteristic.

The present patent document claims the benefit of U.S. Provisional Ser. No. 63/699,263 , filed Sep. 26, 2024, which is hereby incorporated by reference in its entirety.

### TECHNICAL FIELD

The present disclosure is directed, in general, to software management systems, in particular systems for developing apps, which may be used to manage, build, test, deploy, and iterate such apps (collectively referred to here-in as product systems).

### BACKGROUND

Recently, an increasing number of computer software products is used both for personal needs and for business needs in the form of applications, throughout the present patent document simply called “apps.” Such apps may be used in a mobile context as well as on cloud computing platforms and “on premise” and may provide a specific set of functions. The present disclosure relates to the development and the creation of such apps, such as creating an app including app characteristics.

Currently, there exist product systems and solutions which support managing or developing such apps. Such product systems may benefit from improvements.

### SUMMARY

Variously disclosed embodiments include methods and computer systems that may be used to facilitate creating an app, such as creating an app including app characteristics.

According to a first aspect, a computer-implemented method for creating an app including app characteristics may include: providing an app development UI of an app development platform to a user for developing the app; providing a default program prompt associated with a large language model, wherein the default program prompt includes a first prompt to generate one or more function calls relating to default app characteristics matching received user input; receiving natural language user input indicative of at least one app characteristic of the app; determining the respective app characteristic using the default program prompt, the received user input and the large language model; and developing the app using the respective determined app characteristic.

According to a second aspect, a computer system may be arranged and configured to execute the acts of this computer-implemented method according to the first aspect.

According to a third aspect, a computer program product may include computer program code that, when executed by the computer system according to the second aspect, causes the computer system to carry out the method according to the first aspect.

According to a fourth aspect, a computer-readable medium may include the computer program product according to the third aspect. By way of example, the described computer-readable medium may be non-transitory and may further be a software component on a storage device.

The foregoing has outlined broadly the technical features of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiments disclosed as a basis for modifying or designing other structures for carrying out the same purposes of the present disclosure. Those skilled in the art will also realize that such equivalent constructions do not depart from the spirit and scope of the disclosure in its broadest form.

Also, before undertaking the detailed description below, various definitions for certain words and phrases are provided throughout this patent document and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

Embodiments are described below in greater detail.

### BRIEF DESCRIPTION OF THE DRAWINGS

FIG. 1 depicts a functional block diagram of an example system that facilitates creating an app, such as creating an app including app characteristics, in a product system.

FIGS. 2-4 depict different aspects of various example methodologies that facilitate creating an app, such as creating an app including app characteristics, in a product system, respectively.

FIGS. 5-6 depict a functional block diagram of further example systems that facilitate creating an app, such as creating an app including app characteristics, in a product system, respectively.

FIG. 7 depicts a flow diagram of an example methodology that facilitates creating an app, such as creating an app including app characteristics, in a product system.

FIG. 8 depicts a block diagram of a data processing system in which an embodiment may be implemented.

### DETAILED DESCRIPTION

Various technologies that pertain to systems and methods for creating an app, such as creating an app including app characteristics, in a product system are now described with reference to the drawings, where like reference numerals represent like elements throughout. The drawings discussed below, and the various embodiments used to describe the principles of the present disclosure in this patent document, are by way of illustration only and should not be construed in any way to limit the scope of the disclosure. Those skilled in the art will understand that the principles of the present disclosure may be implemented in any suitably arranged apparatus. It is to be understood that functionality that is described as being carried out by certain system elements may be performed by multiple elements. Similarly, for instance, an element may be configured to perform functionality that is described as being carried out by multiple elements. The numerous innovative teachings of the present patent document will be described with reference to exemplary non-limiting embodiments.

An app may refer to a software program which on execution performs specific desired tasks. In certain examples, several apps are executed in a runtime environment containing one or more operating systems (“OSs”), virtual machines (e.g., supporting Java™ programming language), device drivers, etc.

Apps, including native apps, may be created, edited, and represented using traditional source code. Examples of such traditional source code include C, C++, Java, Flash, Python, Perl, and other script-based methods of representing an app. Developing, creating, and managing such script-based apps, or parts of such script-based apps, may be accomplished by manual coding of suitably trained users.

Developers may use Application Development Frameworks (“ADFs”) (which are by themselves applications or apps) for implementing/developing desired apps. An ADF provides a set of pre-defined code/data modules that may be directly/indirectly used in the development of an app. An ADF may also provide tools such as an Integrated Development Environment (“IDE”), code generators, debuggers, etc., which facilitate a developer in coding/implementing the desired logic of the app in a faster/simpler manner.

In certain examples, an ADF simplifies app development by providing reusable components that may be used by app developers to define user interfaces (“UIs”) and app logic by, for example, selecting components to perform desired tasks and defining the appearance, behavior, and interactions of the selected components. Some ADFs are based on a model-view-controller design pattern that promotes loose coupling and easier app development and maintenance.

According to another approach, apps may also be created, edited, and represented using visual model-based representations. Unlike traditional source code implementations, such apps may be created, edited, and/or represented by drawing, moving, connecting, and/or disconnecting visual depictions of logical elements within a visual modeling environment. Visual model-based representations of apps may use symbols, shapes, lines, colors, shades, animations, and/or other visual elements to represent logic, data, or memory structures or user interface elements. In order to program a traditional script-based app, programmers may be required to type out detailed scripts according to a complicated set of programming syntax rules. In contrast, programming a visual model-based app may be done by connecting various logical elements (e.g., action blocks and/or decision blocks) to create a visual flow chart that defines the app's operation. Similarly, defining data structures (e.g., variable types, database objects, or classes) and/or user interface elements (e.g., dropdown boxes, lists, text input boxes) in a visual model-based app may be done by drawing, placing, or connecting visual depictions of logical elements within a virtual workspace, as opposed to typing out detailed commands in a script. Visual-model based apps, including native apps, may therefore be more intuitive to program and/or edit compared to traditional script-based apps. In the present document, an approach is suggested to manage apps, such as creating an app including app characteristics, which may involve the explained visual model-based representations.

For brevity, references to a “model,” a “visual model,” or an “application” or “app” may refer to visual model-based apps, including native apps, unless specifically indicated. In some cases, such visual model-based apps may represent complete, stand-alone apps for execution on a computer system. Visual model-based apps may also represent discrete modules that are configured to perform certain tasks or functions, but which do not represent complete apps. Instead, such discrete modules may be inserted into a larger app or combined with other discrete modules to perform more complicated tasks. Examples of such discrete modules may include modules for validating a ZIP code, for receiving information regarding current weather from a weather feed, and/or for rendering graphics.

Visual models may be represented in two forms: an internal representation and one or more associated visual representations. The internal representation may be a file encoded according to a file format used by a modeling environment to capture and define the operation of an app (or part of an app). For example, the internal representation may define what inputs an app may receive, what outputs an app may provide, the algorithms and operations by which the app may arrive at results, what data the app may display, what data the app may store, etc. The internal representation may also be used to instruct an execution environment how to execute the logic of the app during run-time. Internal representations may be stored in the form of non-human-readable code (e.g., binary code). Internal representations may also be stored according to a binary stored JSON (java script object notation) format, and/or an XML format. At run-time, an execution engine may use an internal representation to compile and/or generate executable machine code that, when executed by a processor, causes the processor to implement the functionality of the model.

The internal representation may be associated with one or more visual representations. Visual representations may include visual elements that depict how an app's logic flows, but which are not designed to be compiled or executed. These visual representations may include flow-charts or decision trees that show a user how the app will operate. The visual models may also visually depict data that is to be received from the user, data that is to be stored, and data that is to be displayed to the user. These visual models may also be interactive, which allows a user to manipulate the model in an intuitive way. For example, visual representations may be configured to display a certain level of detail (e.g., number of branches, number of displayed parameters, granularity of displayed logic) by default. However, users may interact with the visual representation in order to show a desired level of detail. For example, users may display or hide branches of logic, and/or display or hide sets of parameters. Details relating to an element of the visual model may be hidden from view by default but may appear in a sliding window or pop-up that appears on-screen when the user clicks on the appropriate element. Users may also zoom in or out of the model, and/or pan across different parts of the model, to examine different parts of the model. Users may also copy or paste branches of logic from one section of the model into another section, or copy/paste branches of logic from a first model into a second model. In some cases, parts of the model may contain links to other parts of the model, such that if a user clicks on a link, the user will automatically be led to another part of the model. A viewing user may interact with a visual representation in at least some of the same ways that the viewing user might interact with the model if it were displayed within a modeling environment. In other words, the visual representation may be configured to mimic how the model would appear if it were displayed within a visual modeling environment. A single internal representation may correspond to multiple visual representations that use different styles or formatting rules to display app logic. For instance, multiple visual representations corresponding to the same internal representation may differ from one another in their use of color, elements that are included or omitted, and use of symbols, shapes, lines, colors, and/or shades to depict logic flow.

Approaches involving the above-described functionalities of visual model-based representations, visual model-based apps, and/or visual models are sometimes understood to be included by a so-called low-code application development platform or low-code app development platform. By way of example, such a low-code application development platform may further be described as software that provides a development environment used to create application software through graphical user interfaces and configuration instead of traditional hand-coded computer programming. A low-code model may enable developers of varied experience levels to create applications using a visual user interface in combination with model-driven logic. Such low-code application development platforms may produce entirely operational apps or require additional coding for specific situations. Low-code app development platforms may reduce the amount of traditional hand coding, enabling accelerated delivery of business apps. A common benefit is that a wider range of people may contribute to the app's development, e.g., not only those with formal programming skills. Low-code app development platforms may also lower the initial cost of setup, training, deployment, and maintenance.

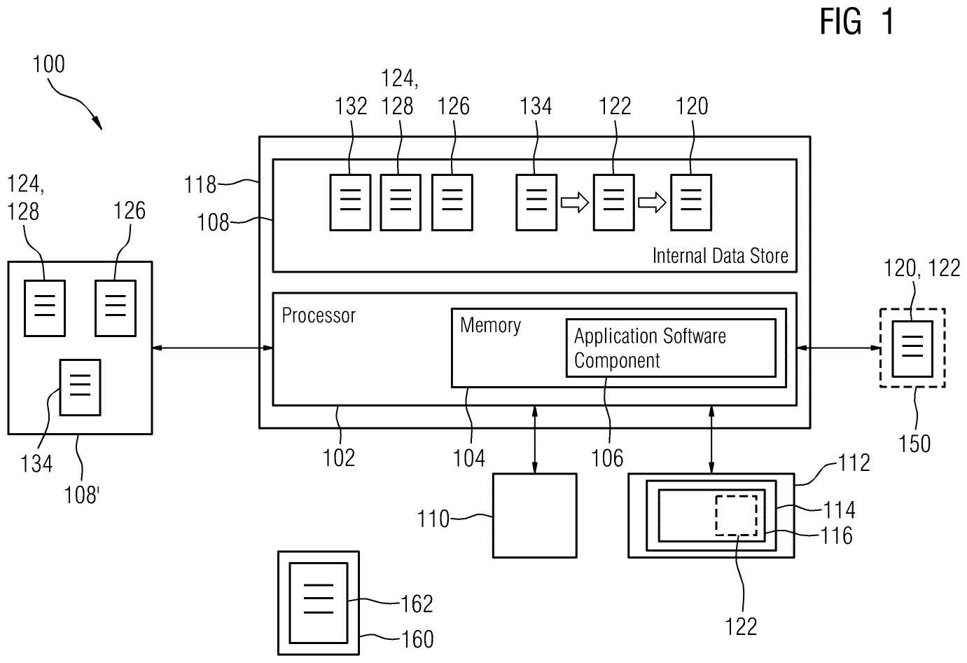

With reference to FIG. 1, a functional block diagram of a first example computer system or data processing system 100 is depicted that facilitates creating an app 120, such as creating an app 120 including app characteristics 122, in a product system 100. The processing system 100 may include an app development platform 118 that may include at least one processor 102 configured to execute at least one application software component 106 from a memory 104 accessed by the processor 102. The application software component 106 may be configured (i.e., programmed) to cause the processor 102 to carry out various acts and functions described herein. For example, the described application software component 106 may include and/or correspond to one or more components of an application for creating an app 120, such as creating an app 120 including app characteristics 122, wherein the application software component 106 may be configured to generate and store product data in a data store 108 such as a database.

By way of example, the app development platform 118 may be cloud-based, internet-based, and/or be operated by a provider providing support for creating an app 120, such as creating an app 120 including app characteristics 122. In some examples, the user may be located close to the app development platform 118 or remote to the app development platform 118, e.g., anywhere else, e.g., using a mobile device for connecting to the app development platform 118, e.g., via the internet, wherein the mobile device may include an input device 110 and a display device 112. In some examples, the app development platform 118 may be installed and run on a user's device, such as a computer, laptop, pad, on-premises computing facility, or the like.

Examples of product systems that may be configured to include the app management and/or development, such as for creating an app 120 including app characteristics 122 features described herein, may include the low-code software development platform of Mendix Inc., of Boston, Massachusetts, USA. This platform provides tools to build, test, deploy, iterate, develop, create, and manage apps 120 and is based on visual, model-driven software development. However, the systems and methods described herein may be used in other product systems (e.g., product lifecycle management (PLM), product data management (PDM), application lifecycle management (ALM) systems) and/or any other type of system that generates and stores product data in a database. Also, examples of databases that may be used as one or more data stores described herein include database server ap-plications such as Oracle™, Microsoft™ SQL Server, or any other type of data store that is operative to store data records.

Creating an app 120, such as creating an app 120 including app characteristics 122, may be a challenging and time-consuming process that may require highly skilled developers with many years of training and expert domain knowledge. For example, apps 120 and app characteristics 122 may become increasingly complex and there may yet be a big need to create a corresponding app 120 or to extend an existing app 120 fast. Further, an increasing lack of skilled developers leads to the necessity to enable or at least facilitate creating an app 120 including app characteristics 122 for persons without specific software development experience or IT knowledge. In certain examples, for developing apps 120, such as creating an app 120 including app characteristics 122, there is a desire for faster and more convenient app development and eventually deployment of such apps 120 on target devices 150.

To enable the enhanced creation of an app 120, such as creating an app 120 including app characteristics 122, the described product system or processing system 100 may include at least one input device 110 and at least one display device 112 (such as a display screen). The described processor 102 may be configured to generate a graphical user interface (GUI) 114 through the display device 112. Such a GUI 114 may include GUI elements such as buttons, links, search boxes, lists, text boxes, images, and/or scroll bars usable by a user to provide inputs through the input device 110 that cause creating an app 120, such as creating an app 120 including an app characteristics 122. By way of example, the GUI 114 may include an app development user interface (UI) 116 provided to a user.

In an example embodiment, the application software component 106 and/or the processor 102 may be configured to provide an app development UI 116 of an app development platform 118 to a user for developing the app 120, wherein the app may include app characteristics 122.

As mentioned above, the app development platform 118 may provide or include the above-described functionalities of the development and the creation of an app 120, such as creating an app 120 including app characteristics 122. In some examples, the app development platform 118 may support visual model-based representations, visual model-based apps, and/or visual models and, by way of example, may be a visual model-based app development platform or a low-code app development platform. The app development UI 116 may provide an interactive user interface of the app development platform 118 which supports and enables the user to develop the app 120. By way of example, the app 120 may be or include a software program which on execution performs specific desired tasks.

The app 120 to be developed may be used by an end user for industrial and/or business purposes. An industrial purpose may be to use the developed app 120 for analyzing, monitoring, controlling, and/or managing an industrial field device or plant including several such fields devices, wherein the mentioned devices or plants may correspond to a target device 150, which is explained in more detail below. A business purpose may be to use the developed app 120 for shopping or retail, e.g., to generate or manage customer orders of a hardware or software product.

In some examples, the app characteristics 122 may characterize the app 120 or at least a part of the app 120, wherein further details and examples of the app characteristics 122 are provided below. In some examples, the app characteristics 122 may include information on the look and feel, a functionality, or a model, of the app 120, respectively.

In some examples, the application software component 106 and/or the processor 102 may further be configured to provide a default program prompt 124 associated with a large language model 126, wherein the default program prompt 124 may include a first prompt 128 to generate one or more function calls 130 relating to default app characteristics 132 matching received user input 134.

A large language model (LLM) 126 may be understood as a computational model capable of language generation or other natural language processing tasks. As language models, LLMs 126 may acquire these abilities by learning statistical relationships from vast amounts of text during a self-supervised and semi-supervised training process. In some examples, LLMs 126 may use artificial neural networks built with a decoder-only transformer-based architecture, which may enable efficient processing and generation of large-scale text data. These models may acquire knowledge about syntax, semantics, and ontologies. The artificial neural networks of LLMs 126 may contain a billion to a trillion weights and are (pre-)trained using self-supervised learning and semi-supervised learning. Some notable LLMs 126 include among others OpenAI's GPT series of models, Google's Gemini, Meta's LLaMA family of models, and IBM's Granite.

In certain examples, a prompt may be understood as instructions issued to a computer system in the form of written or spoken language. In the context of LLMs 126, the default program prompt 124 may have some similarities to a system prompt, by way of example, in that the default program prompt 124 may guide the way the LLM 126 may interpret and respond to user queries. In some examples, the default program prompt 124 may include instructions serving as the guiding light for the LLM 126, directing the LLM's 126 behavior and providing that the generated outputs align with the intended goals. By way of example, the default program prompt 124 may include a set of instructions, guidelines, and/or contextual information provided to the LLM 126 before the LLM 126 starts to engage with user queries. In the present context, the default program prompt 124 may particularly be configured to support the creation of the app 120 and may further take into account the default app characteristics 122.

The default app characteristics 132 may include app characteristics 132 for one or more predefined types of apps 120. For example, for the above-mentioned industrial purposes, the default app characteristics 132 may include control functionalities to control a target device 150 on which the app 120 may be deployed and run or which may be controlled via control signals provided by the deployed and running app 120. Herein, the control functionalities included in the default app characteristics 132 may rely on input data received by the target device 150 or another device which is associated or coupled with the target device 150, wherein the app 120 may, according to the default app characteristics 132, process the input data to determine the control signals in line with the control functionalities. In another example in the industrial domain, the default app characteristics 132 may include monitoring functionalities according to which, based on input data received by the target device 150 or another device which is associated or coupled with the target device 150, an analysis and a comparison against predefined threshold values may be done to do condition monitoring with respect to the target device 150 or the other device, e.g., to determine if the respective device is operated as expected or abnormally, e.g., due to wear, a defect or a malfunction of the respective device.

The default program prompt 124 may include a first prompt 128 which may generate one or more function calls 130 which may be understood as an expression that passes control and arguments (if any) to a function and may have the form: “expression (expression-listopt)”. Hence, the respective function call 130 may be used to integrate the LLM 126. In some examples, the default app characteristics 132 may include metadata describing available function calls 130 and the relation of the respective function call 130 to at least one of the default app characteristics 132.

In the above example with the control functionalities to control a target device 150 on which the app 120 may be deployed and run or which may be controlled via control signals provided by the deployed and running app 120, the default program prompt 124 may include a first prompt 128 to generate a first function call 130 to query input data from the respective device, a second function call 130 to process the queried input data to generate control signals as output data, and a third function call 130 to transmit the generated control signals to the respective device. These three function calls 130 may be associated with corresponding default app characteristics 132 for controlling a respective device. Further examples of such function calls 130 are provided below.

Herein, one or more suitable app characteristics 122 may be selected from the default app characteristics 132 depending on how well received user input matches the default app characteristics 132. By way of example, there may be a variety of default app characteristics 132 for various industrial or business purposes, wherein the user of the app development platform 118 may provide user input 134 relating to the above-mentioned control functionalities example so that in this case, the default app characteristics 132 associated with the above-mentioned three function calls 130 may be determined and used for the creation of a suitable app 120.

By way of example, using function calls 130 may result in a beneficial decoupling such that the LLM 126 may be less specific to certain types of apps 120, app characteristics 122 or industrial or business use cases. The specifics, e.g., of industrial or business use cases, may be included in the default program prompt 124, the app characteristics 122, and/or the respective related function call 130.

The default program prompt 124, the LLM 126, the default app characteristics 132 and/or the function calls 130 may be provided and stored in the data store 108 of the app development platform 118, e.g., by the user using the app development UI 116 and/or the input device 110. In some examples, the default program prompt 124, the LLM 126, the default app characteristics 132 and/or the function calls 130 may be received, e.g., via an application programming interface (API), from another data source 108′ or from the internet.

In further examples, the application software component 106 and/or the processor 102 may further be configured to receive natural language user input 134 indicative of at least one app characteristic 122 of the app 120.

To create the app 120 with desired app characteristics 122, the user of the app development platform 118 may provide the user input 134 in natural language, e.g., in written form using a keyboard as the input device 110 and using an input text box of the app development UI 116, wherein oral input may also be possible, e.g., using a microphone as the input device 110. By way of example, if the user provides the desired app characteristics 122 in natural language, the app development platform 118 may analyze the user input 134 to derive corresponding app characteristics 122. In further examples, the user of the app development platform 118 may make selections from predefined app characteristics 122, e.g., the default app characteristics 132, wherein the available app characteristics 122 may be displayed to the user via the app development UI 116, and wherein a combination of natural language user input and a selection from predefined app characteristics 122 may be possible. In further examples, the user may provide the user input 134 by chatting with a chatbot which may be understood to be a software application or web interface that is designed to mimic human conversation through text or voice interactions.

By way of example, the application software component 106 and/or the processor 102 may further be configured to determine the respective app characteristic 122 using the default program prompt 124, the received user input 134, and the large language model 126.

In some examples, to determine the respective app characteristic 122, the received user input 134 may be analyzed using the default program prompt 124 and the LLM 126. By way of example, the received user input 134 and the default program prompt 124 may be provided as input data to the LLM 126, wherein the output data of the LLM 126 may be the respective app characteristic 122. The output data of the LLM 126 may further include one or more function calls 130 which are associated with the respective app characteristic 122 matching the received user input 134.

The respective match between the respective default app characteristic 132 and the received user input 134 may indicate that a particular default app characteristic 132 has sufficiently good agreement or similarity with the app characteristic 122 indicated by the user via the received user input 134. In some examples, there may be a plurality of default app characteristics 132 that may be available for developing the app 120 as intended by the user of the app development platform 118. The user may provide the user input 134 indicative of at least one app characteristic 122 of the app 120, wherein the user input 134 may be compared with the available default app characteristics 132 using the default program prompt 124 and the large language model 126 to identify the one or more default app characteristics 132 that best fit to the user's intend as expressed in the received user input 134. The respective matching default app characteristic 132 may then be identified as the respective app characteristic 122 matching the received user input 134. By way of example, the received user input 134 may be indicative of one or more well-matching default app characteristics 132, wherein according to the received user input 134 adaptations to the respective well-matching default app characteristic 132 may be required. In such examples, using the default program prompt 124 and the LLM 126, the respective well-matching default app characteristic may be configured according to the received user input 134 to eventually obtain the respective, desired app characteristic 122.

In further examples, to perform the described matching, the application software component 106 and/or the processor 102 may further be configured to determine a respective similarity value between the respective default app characteristic 132 and the received user input 134, and to determine the respective match based on the determined similarity values. Herein, the software component 106 and/or the processor 102 may use the default program prompt 124 indicating the desired matching and the large language model 126. The respective similarity value may be understood as a real-valued function that quantifies the similarity between two objects, here the respective default app characteristic 132 and the received user input 134. In some examples, the similarity may further be understood as the inverse of distance metrics: the similarity values may take on large values for similar objects and either zero or a negative value for very dissimilar objects. Though, in more broad terms, a similarity function may also satisfy metric axioms. By way of example, the cosine similarity may be used as a measure for real-valued vectors for information retrieval to score the similarity of the respective default app characteristic 132 and the received user input 134. By way of example, if the respective similarity value is below a pre-defined threshold, the received user input 134 may be indicative of the necessity of adaptations to the above-mentioned, respective well-matching default app characteristic 132 may be required.

In some examples, the application software component 106 and/or the processor 102 may further be configured to develop the app 120 using the respective determined app characteristic 122.

Using the respective determined app characteristic 122, the app 120 may be developed using the app development platform 118. Herein, the app development platform 118 together with the default program prompt 124 and the LLM 126 may be particularly suitable to support non-expert users to create and develop their desired app characteristics 122 and then to develop the app 120 including the app characteristic 122. Especially for non-expert users, providing their user input 134 in natural language and, e.g., not using algorithms, step-by-step specifications of procedures, or writing code in one or more programming languages, may make the suggested approach very accessible, convenient, and efficient.

In further examples, the determined respective app characteristic 122 includes a respective graph 136, wherein the respective graph 136 may include a plurality of entities 138 associated with the respective app characteristic 122.

Herein, a graph 136 may be understood as a structure including a set of objects where some pairs of the objects are in some sense “related.” The objects may be represented by abstractions called vertices, also called nodes or points, and each of the related pairs of vertices is called an edge, also called link or line. In certain examples, a graph may be depicted in diagrammatic form as a set of dots or circles for the vertices, joined by lines or curves for the edges.

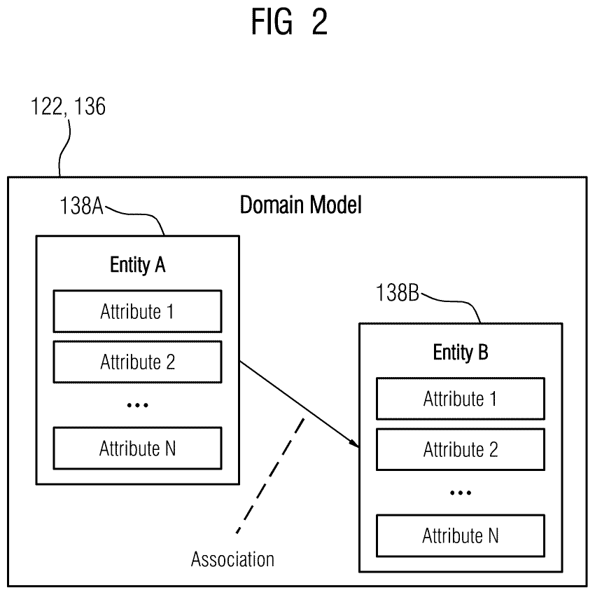

In the present context, the objects or nodes of the graph 136 may include a plurality of entities 138, wherein an entity 138 may be compared to a table in traditional SQL. Entities 138 may have attributes—which may be thought of as fields—and may have primitive types like string, int, and date-time. Entities 138 may relate to each other either 1-1, 1-*, or *-* so that the graph 136 may have corresponding edges. The edges of the graph 136 may also be considered to be associations as sketched in FIG. 2 linking two or more entities 138.

In the context of the above industrial example, the respective app characteristic 122 may include control functionalities to control a target device 150 on which the app 120 may be deployed and run or which may be controlled via control signals provided by the deployed and running app 120. One of the entities 138 included in the graph 136, which is included in the respective app characteristic 122, may describe some properties of the target device 150, such as an identifier, and a type of target device 150 (e.g., a PLC controlling an electric motor). In this example, the app 120 may eventually be deployed and run on the target device 150 (here: the PLC). The device coupled with the target device 150 may be another entity 138 with an identifier, a type of device (e.g., an electric motor), a rated output power (e.g., 5 kW), and a maximum rotational speed (e.g., 3000 rpm). In some examples, the mentioned properties may be called “attributes” of the respective entity 138 as sketched in FIG. 2. Another of the entities 138 included in the graph 136 may describe some properties of a complex machine including the target device 150, wherein the target device 150 drives the complex machine with a certain actual rotational speed. To control the coupled device (here: the electric motor), the actual rotational speed of the coupled device may be determined, e.g., by the target device 150 (here: the PLC), wherein in simple examples, a comparison with the maximum rotational speed may be done and, if the actual rotational speed is larger than the maximum rotational speed, the target device 150 may control the coupled device to reduce the actual rotational speed below the maximum rotational speed. Herein, the comparison and the corresponding control signal may be performed by a corresponding algorithm that may be considered as a rule, workflow, logic, or functionality which are explained in more detail below.

By way of example, the respective default app characteristic 132 may include at least one of a default model, a default rule, a default workflow 140, a default logic, a default functionality, a default user interface, a default API, a default target operation environment of a default app 120, respectively, or any combination thereof, and/or the respective app characteristic 122 may include at least one of a model, a rule, a workflow 140, a logic, a function, a user interface, an API, a functionality, a target operation environment of the app, respectively, or any combination thereof.

By way of example, the respective default model may be understood in the above-described context of model-based app development. The respective default model may describe the information or data used by the app 120, e.g., in a visual way, e.g., in the form of the above-mentioned graph 136. In some examples, the graph 136 and the (default) model may be used interchangeably. Further, the respective default model may be a data model which may abstract the structure of a relational database management system (RDBMS) which may store the industrial or business data which may power the app 120. By way of example, the respective default model may include the above-mentioned entities 138 with their relationships to other entities 138 represented by associations, as sketched in FIG. 2. In some examples, the associations may allow entities 138 to communicate with one another. By way of example, the respective entity 138 may have one or more attributes which may correspond to properties of the respective entity 138. The respective default rule, default workflow 140, default logic, and default functionality may describe how entities 138 may relate to each other in terms of data manipulation, e.g., to derive output data from input data using an algorithm, wherein the algorithm may correspond to the respective default rule, default workflow 140, default logic, and default functionality. By way of example, the default model may characterize (at least some aspects) the app 120 to be created and/or functionalities of the app 120 to be created, wherein in further examples, the default model may include one or more workflows 140 for processing data related to the entities 138 or pages of the app 120, wherein the pages may serve to display information of the entities 138 or information derived from the entities 138, to an app user, e.g., via a UI of the app 120.

In the context of the above industrial example, the input data may be the properties of the coupled entity 138 “electric motor” and the actual rotational speed, wherein the respective default rule, default workflow 140, default logic, or default functionality may derive a control signal as output data from the mentioned input data. Further, the respective default API (application programming interface) may describe how the app 120 may communicate with another app 120 or more with another computer program, computer program component, or data resource. In some examples, the input data and/or the output data of a respective default rule, default workflow 140, default logic, or default functionality may be communicated from or to and another data resource. A default target operation environment of a default app may include information on the standard operating system and/or firmware of widely used standard target devices 150, e.g., used for standard processes managed by standard apps 120, such as monitoring or controlling the mentioned standard target devices 150. In the above industrial example, the default target operation environment may include information on the standard operating system and/or firmware of widely-used PLCs.

While the respective default app characteristic 132 may include the mentioned default data, e.g., covering examples of use cases that may occur and may be used, the respective app characteristic 122 may be specific to the user input 134, e.g., the user's intended functionalities, look and feel, and so on of the desired app 120. Accordingly, the respective app characteristic 122 may include specific data corresponding to the mentioned default data of the respective default app characteristic 132, wherein the specific data of the respective app characteristic 122 may correspond to the user input 134, e.g., the user's intended functionalities, look and feel, and so on of the desired app 120.

In some examples, the respective function call 130 may initiate creating the respective app characteristic 122 matching the received user input 134 and at least one of the default app characteristics 132.

As explained above, the respective default app characteristic 132 and the respective app characteristic 122 may include a (default) model, a (default) workflow 140, or a (default) API, wherein entities 138 may be included by the model, and wherein data processed by the workflow 140 may be communicated from or to another data resource via the API. Further, the default program prompt 124 may include a first prompt 128 to generate one or more function calls 130 relating to default app characteristics 132 matching received user input 134. Hence, in the above industrial example, the first prompt 128 may generate a first function call 130 to determine the actual rotational speed of the coupled device (here: the electric motor), wherein in some examples, the corresponding information of the actual rotational speed may be retrieved via an API, e.g., to communicate with the target device 150 (here: the PLC). Further, the first prompt 128 may generate a second function call 130 to compare the determined actual rotational speed with the maximum rotational speed as defined in the properties of the coupled device. Finally, the first prompt 128 may generate a third function call 130 to adapt the actual rotational speed of the coupled device, if necessary, thus controlling the coupled device. Such a third function call 130 may involve a decision in a workflow 140, wherein depending on input data a decision to execute a first activity (here: adapt the actual rotational speed of the coupled device) or a second activity (here: do nothing) may be determined.

In some examples, there may be a library of available function calls 130 that may cover pre-defined standard scenarios, such as querying input data, processing input data to create output data, displaying output data in a user interface or page of the app 120, communicating output data to another data resource, or to the target device 150, etc. The mentioned library of available function calls 130 may be stored in the data store 108 or 108′ and may be associated with the default app characteristics 132. For example, performing condition monitoring of the target device 150 or another device coupled to the target device 150 may constitute such a standard scenario. By way of example, for the condition monitoring scenario, a function call 130 may include sending an alarm to the user of the app 120, if the target device's 150 (or the coupled device's) operating status is abnormal, wherein another function call 130 may include scheduling a maintenance of the respective device. Further, function calls 130 may include interaction with the user of the app 120, e.g., by displaying some information to the user of the app 120 via a user interface of the app 120, and getting feedback of the user of the app 120, e.g., as natural language input, as a selection of displayed options, etc. Further, the function call 130 may include the above-mentioned decision.

By way of example, the mentioned one or more function calls 130 may be included in the respective rule, workflow 140, logic, and/or functionality that may be structured in the form of the above-mentioned graph 138. E.g., when user input 134 has been received, the first prompt 128 included by the default program prompt 124 may trigger selecting or composing the function calls 130 of the respective app characteristic 122 matching the received user input 134 and at least one of the default app characteristics 132. Herein, the aspects of the matching mentioned above may be applied to the present matching of the function calls 130 and the corresponding, respective app characteristic 122 on the one hand and the received user input 134 and the default app characteristics 132 on the other hand.

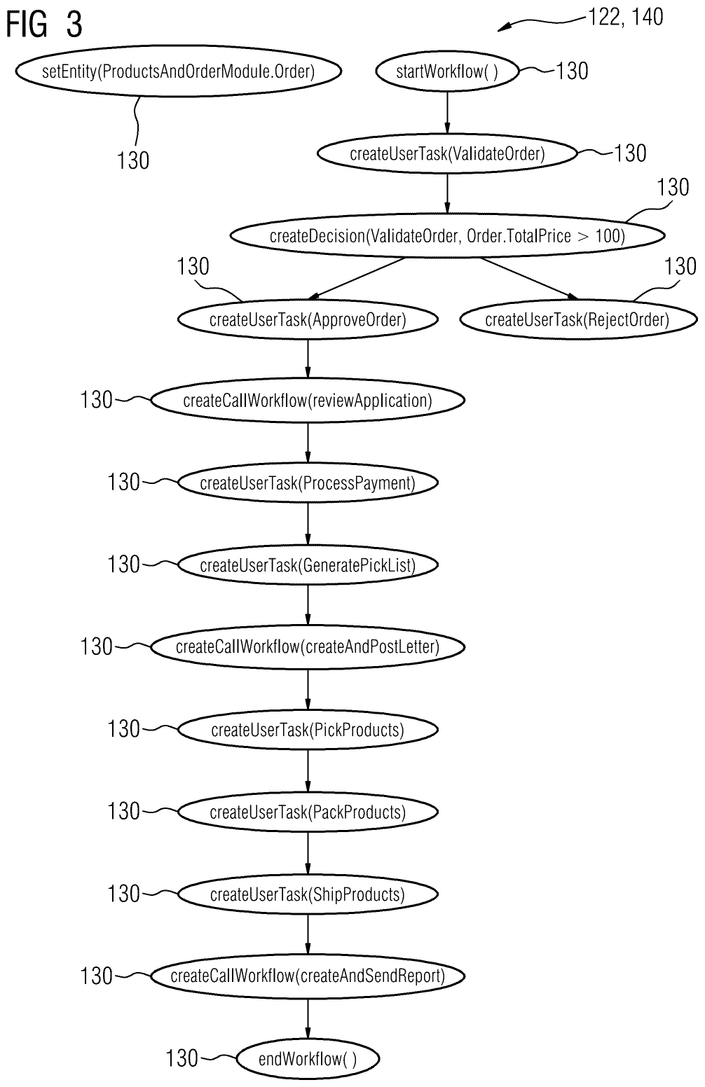

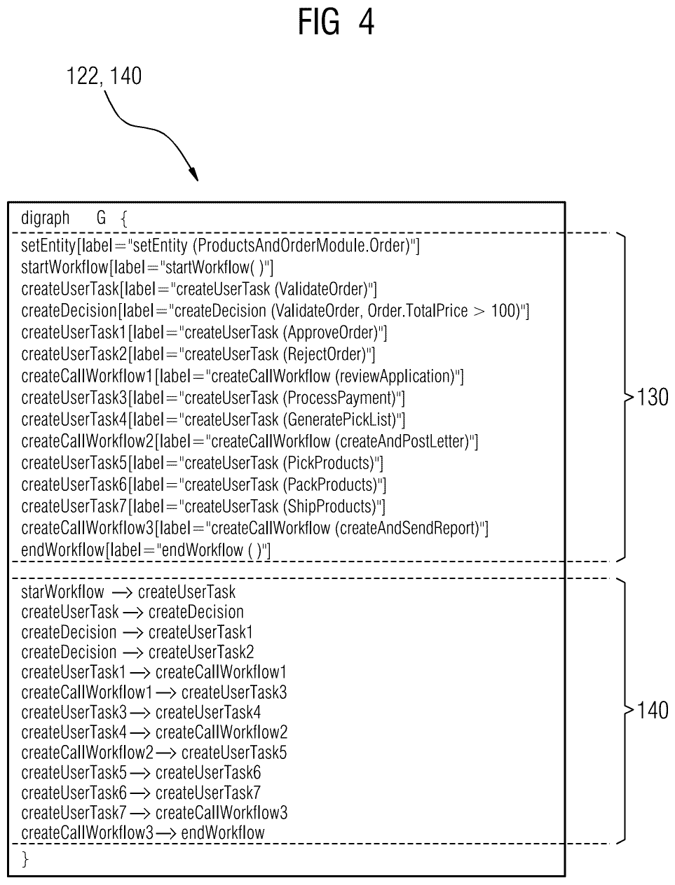

In some examples, the respective function call 130 may have the form “createCallWorkflow(workflowName)”, e.g., “createDecision(AdaptActualSpeed, ActualSpeed>MaximumSpeed)” for the above industrial example of controlling the rotational speed of a coupled device. Further examples are depicted in FIGS. 3 and 4 and are explained below.

In some examples, the respective app characteristic 122 may be associated with model-based app development.

By way of example, the respective app characteristic 122 may include the above-mentioned model and may be developed using the above-mentioned default model, wherein optionally the app development platform 118 may be a model-based and/or low-code app development platform.

As already mentioned above, the respective model may include the above-mentioned entities 138 with their relationships to other entities 138 represented by associations, wherein the respective entity 138 may have one or more attributes which may correspond to properties of the respective entity 138.

By way of example, the default program prompt 124 may further include a second prompt 144 including information on a persona which the large language model 126 shall use.

The second prompt 144 may include characteristics of a system prompt which are known in the context of LLMs 126. By way of example, the second prompt 144 may guide the way the LLM 126 may interpret and respond to user queries and may include instructions serving as the guiding light for the LLM 126, directing their behavior and providing that the generated outputs align with the intended goals. In the present example, the second prompt 144 may include a set of instructions, guidelines, and/or contextual information for a system prompt in form of the persona that the large language model 126 shall use. Herein, the information on the persona may include the information on the persona itself, the persona domain, and/or the persona experience level, e.g., in the form “you are an ambitious and adventurous expert in in low-code app development with ten years of experience” or “you are a conservative and professional expert in condition monitoring of electric motors controlled by a connected PLC with ten years of experience in industrial automation.” Hence, the information on the persona may tell the LLM 126 which role to take and, e.g., which experience level to use as a basis to put the received user input 134 in the right context and, e.g., to create the app 120 as to match the user's intent as well as possible.

By way of example, the second prompt 144 may be pre-configured, e.g., by an administrator of the app development platform 118, and be stored in the data store 108 of the app development platform 118. In further examples, the second prompt 144 may be received, e.g., via an application programming interface (API), from another data source 108′ or from the internet. In some examples, the second prompt 144 may be received by the user using the app development UI 116 and/or the input device 110 or may be determined using the received user input 134.

In further examples, the default program prompt may further include information on the data format 142 of the determined respective app characteristic 122, wherein the data format 142 may be a machine-parsable and/or graph description language format.

A machine-parsable data format 142 may be understood as a data format 142 that may be parsed by the LLM 126, the app development platform 118, or processors 102. Herein, parsing, syntax analysis, or syntactic analysis may be the process of analyzing a string of symbols, either in natural language, computer languages or data structures, conforming to the rules of a formal grammar.

By way of example, Mermaid (cf. https://mermaid.js.org) may be used as the data format 142. Mermaid is a JavaScript-based diagramming and charting tool that renders Markdown-inspired text definitions to create and modify diagrams dynamically. In further examples, the data format 142 may include Business Process Modeling Language (BPML), an XML-based language for business process modeling. In some examples, Anthropic Claude (cf., https://docs.aws.amazon.com/bedrock/latest/userguide/model-parameters-anthropic-claude-text-completion.html) may be used in the context of the data format 142, e.g., “tool use (function calling)” functionality that may enable interacting with external client-side tools and functions. By way of example, the data format 142 may make use of the DOT graph description language which is developed as a part of the Graphviz project. In some examples, the data format 142 may make use of the JSON (JavaScript Object Notation) file format.

In some examples, the respective the data format 142 may be used to illustrate and manipulate the above-mentioned graph 136 or model including the above-mentioned entities 138. Further, in some examples, the LLM 126 may be compatible with the respective the data format 142, e.g., such that the output generated by the LLM 126 is in the respective the data format 142 and may optionally include the graph 136 or model including the above-mentioned entities 138, e.g., without further data format conversion of the determined respective app characteristic 122. The machine-parsable and/or graph description language data format 142 may be beneficial since it may speed up the integration of the LLM 126 in the creation of the app 120 and may lead to higher quality app characteristics 122 in the sense that the user's intent is matched as well as possible. By way of example, the respective the data format 142 may be compatible with the app development platform 118 so that the app development platform 118 may use the determined respective app characteristic 122 to develop the app 120, e.g., without further data format conversion of the determined respective app characteristic 122.

In some examples, the application software component 106 and/or the processor 102 may further be configured to display the determined respective app characteristic 122 in the data format 142 via the app development UI 116; and to develop, by the app development platform 118, the app 120 using the determined respective app characteristic 122 in the data format 142.

Displaying the respective determined app characteristic 122 to the user via the app development UI 116 in the data format 142 may be particularly beneficial since the app characteristics 122 may be displayed to the user in a format which may be easy to preview and verify for a (human) user of the app development platform 118. By way of example, the app characteristics 122 may include a complex graph 136 or model including a plurality of inter-dependent entities 138 with various attributes. The above-explained, respective data format 142 may contribute to display features of the respective app characteristic 122 to the user in a comprehensible manner, e.g., allowing for a deeper analysis if the user requires more information. By way of example, respective app characteristic 122 may be displayed using diagrams or flowcharts. Further, by way of example, the respective the data format 142 may be compatible with the app development platform 118 so that the app development platform 118 may use the determined respective app characteristic 122 to develop the app 120, e.g., without further data format conversion of the determined respective app characteristic 122.

By way of example, the large language model 126 may be trained with other app characteristics 122 of other apps 120, wherein the other apps 120 may optionally be developed with model-based app development.

For example, to increase the efficiency of the integration of the LLM 126 in the creation of the app 120, other app characteristics and more generally other apps may be used as knowledge base and hence as input to train the LLM 126. Such an increased efficiency of the integration of the LLM 126 may make the suggested approach slim, resource-efficient with respect to computing and memory resources, and fast. These efficiency increases may be achieved by benefitting from the results of other app developers who have already developed other apps 120 with other app characteristics 122. By way of example, the other app characteristics may include a model or a graph, a rule, a workflow, a logic, a function, a user interface, an API, a functionality, a target operation environment, corresponding entities with attributes and associations of the other app, wherein optionally one or more of these other app characteristics may further be linked to use cases of the other app, such as business or industrial uses cases including industrial use cases, such as the above-described controlling or monitoring of a respective device use case. In further examples, other app characteristics and more generally other apps which have been developed using model-based and/or low-code app development may be used as input to train the LLM 126 so that the LLM may benefit from the advantages of this app development approach.

By way of example, the application software component 106 and/or the processor 102 may further be configured to display the respective app characteristic 122 to the user via the app development UI 116; to receive further user input 146 indicative of an amendment to the respective app characteristic 122 via the app development UI 116; and to determine a respective amended app characteristic 122′ using the further user input 146.

The user of the app development platform 118 may want to make amendments to the determined app characteristics 122 which may be displayed to the user, e.g., via the app development UI 116. The user may have specific ideas on how to amend the app characteristics 122 to obtain the desired (at least part) of the desired app characteristics 122. In such examples, the user may provide the further user input 146 on changes to be made to the app characteristics 122. Herein, the further user input 146 may be used to determine a respective amended app characteristic 122′ using the first prompt 128 and one or more of the function calls 130 which match the further user input 146 and optionally the user input 134, e.g., if the further user input 146 and the user input 134 include or contain complementary information on the desired app 120 or app characteristics 122. In some examples, the further user input 146 may be provided in natural language, as explained above in the context of the user input 134.

In further examples, the application software component 106 and/or the processor 102 may further be configured to deploy the app 120 on a target device 150.

In some examples, the respective target device 150 may be physically connected or communicatively connected to another device or connected such, that the respective target device 150 may at least detect input data from the other device, e.g., by optically inspecting the other device. The respective target device 150 and/or the other device may be or include a sensor, an actuator, such as an electric motor, a valve or a robot, an inverter supplying an electric motor, a gear box, a programmable logic controller (PLC), a communication gateway, and/or other parts or components relating to industrial automation products and industrial automation in general. The respective target device 150 may be part of a complex production line or production plant, e.g., a bottle filing machine, conveyor, welding machine, welding robot, etc. In some examples, if the other device belongs to a lower level of the automation pyramid, such as the sensor/actuator or the field level, then the respective target device 150 may belong to a higher level of the automation pyramid, such as field level or the control level.

By way of example, the respective target device 150 may have an internal data store in which the deployed and operable app 120 may be stored. The respective target device 150 may, by way of example, further include a processor and a display device. The described processor may be configured to generate a target device GUI through the display device, wherein the GUI may include a target device operation UI provided to a user of the target device. The developed and deployed app may have an app UI which may be displayed to the user of the target device 150 via the target device operation UI. In some examples, the target device 150 may include a corresponding UI capable of outputting information of the app 120 optically, haptically, or audibly.

Further, the app 120 may be understood as deployed if the activities which are required to make this app 120 available for use by the app end user on the respective target device 150 are completed. The app deployment process may include several interrelated activities with transitions between them. These activities may occur at the producer side (e.g., by the app developer) or at the consumer side (by the app user or end user) or both. In some examples, the app deployment process may include at least the release of the app 120 and the installation and the activation of the app 120. The release activity may follow from the completed development process and is sometimes classified as part of the development process rather than deployment process. It may include operations required to prepare a system (here: e.g., the app development platform 118 or an online app store) for assembly and transfer to the computer system(s) (here: e.g., the respective target device 150) on which it will be run in production. Therefore, it may sometimes involve determining the resources required for the system to operate with tolerable performance and planning and/or documenting subsequent activities of the deployment process. For simple systems, the installation of the app 120 may involve establishing some form of command, shortcut, script, or service for executing the software (manually or automatically) of the app 120. For complex systems, it may involve configuration of the system (e.g., by asking the end user questions about the intended app use, or directly asking them how they would like it to be configured) and/or making all the required subsystems ready to use. Activation may be the activity of starting up the executable component of software or the app 120 for the first time (which is not to be confused with the common use of the term activation concerning a software license, which is a function of Digital Rights Management systems).

In further examples, the app 120 including the app characteristics 122 may be deployed and run on the target device 150, wherein the deployed and running app 120 may then be used to analyze, monitor, control, and/or operate the target device 150.

For illustration purposes, an example default program prompt 124 may have the following content, wherein “user prompt” corresponds to the user input 134 (and/or optionally the further user input 146), and wherein the data format 142 involves a JSON file format:

“““Human: Generate the function calls to create a Workflow to match the given workflow description, database model (starting from one table) and other available workflows. Workflow description: ‘{user_prompt}’.
FUNCTIONS:{FUNCTIONS}The output MUST be as *valid* JSON only.
WORKFLOWS:{WORKFLOWS}
   DO NOT write any text outside the “‘json’”
   block. TABLESSCHEMA:“‘table_schema ’”
PROCESS:
   1. Create a DOT format file, where each node is a call to a function in the FUNCTIONS list.—example: “‘setEntity[label=“setEntity(myModule. myEntity)”] startWorflow[label=“startWorflow( )”] endWorkflow[label=“endWorkflow( )”]’”
   2. Start with a node to call the setEntity( ) function. If you do not know the name of the start entity, then ask the user.
   3. Next, make a node to call the startWorkflow( ) function call. Next, create the other nodes to make function calls to build the overall workflow process to match the workflow description, using the given FUNCTIONS.
   4. Check that all nodes have at least one link to or from the node.6. Output in DOT format.
   Assistant:“‘{prelude}”””
   “PRELUDE”: prompt engineering trick to get the right output format; here: DOT format

### PRELUDE=“digraph G {”

The described the application software component 106 and/or the processor 102 may carry out an analogous method of creating an app 120, such as creating an app 120 including app characteristics 122, in a product system 100. Also, the explained examples may be combined to obtain a more detailed method of creating an app 120, such as creating an app 120 including app characteristics 122. Further, a computer-readable medium 160 which may include a computer program product 162 is shown in FIG. 1, wherein the computer program product 162 may be encoded with executable instructions, that when executed, cause the product system 100 or and/or the app development platform 118 to carry out the described method.

Among the advantages of the suggested method is that the suggested approach may execute a complete generation of an app 120 instead of being limited to providing only recommendations with respect to the very next act during the creation of an app 120. Hence, the suggested method may speed up creating high quality apps 120, e.g., including workflows 140 and other SW-development-related information so that there is a big customer impact which the users of the app development platform 118 may experience.

Furthermore, e.g., compared to ChatGPT and other LLM approaches, the suggested method may be carried out by an LLM which may be light-weight, low-code-specific, app development-specific, low-code-trained, and/or app development-trained so that in some examples not a big comprehensive LLM may be used in the suggested method which may make the suggested method slim, resource-efficient with respect to computing and memory resources, and fast.

FIG. 2 depicts a first aspect of an example methodology that facilitate creating an app 120, such as creating an app 120 including app characteristics 122, in a product system 100.

In the depicted example, the app characteristic 122 includes a graph 136 or model depicted as “domain model.” The graph 136 or model includes two entities 138A and 138B which have a plurality “N” attributes characterizing the respective entity 138A and 138B. The two entities 138A and 138B are associated with each other via an association. By way of example, two entities 138A and 138B may correspond to the PLC and the electric motor explained above in the context of the industrial controlling use case.

FIG. 3 depicts a second aspect of an example methodology that facilitate creating an app 120, such as creating an app 120 including app characteristics 122, in a product system 100.

In the depicted example, the app characteristic 122 includes a plurality of function calls 130, wherein all except one of these function calls 130 are arranged in a workflow 140 of consecutively executed function calls 130. In some examples, the argument of the respective function call 130 may be a workflow item of the corresponding workflow 140 of the app 120 to be developed, wherein the workflow 140 may process one of more attributes of the entities 138 of a graph 136 or model, such as the graph 136 or model depicted in FIG. 2. In further examples, the respective workflow item of the corresponding workflow 140 of the app 120, e.g., the “ProcessPayment” workflow item, may itself include one or more sub-workflows which may retrieve input data, process the input data, and create output from the processed input data.

The depicted app characteristic 122 may be determined using the default program prompt 124, the received user input 134 and the large language model 126 as explained above.

Further, the app characteristic 122 depicted in FIG. 2 is depicted in a schematic of visual manner.

FIG. 4 depicts a third aspect of an example methodology that facilitate creating an app 120, such as creating an app 120 including app characteristics 122, in a product system 100.

While the app characteristic 122 depicted in FIG. 2 is depicted in a schematic of visual manner, the app characteristic 122 depicted in FIG. 3 is available in a machine-parsable or a graph description language format.

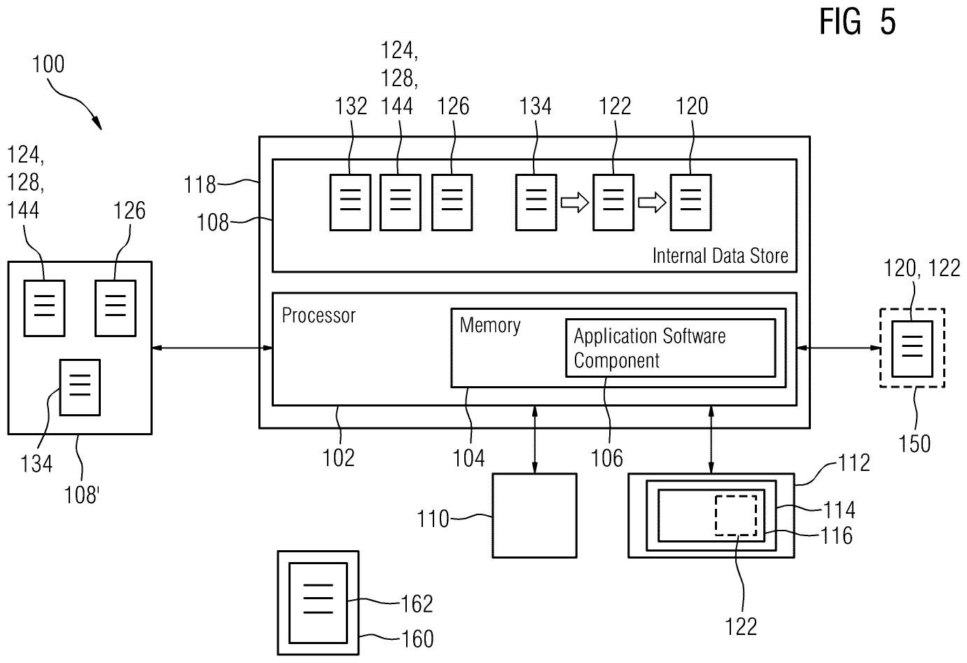

FIG. 5 depicts a functional block diagram of a further example product system 100 that facilitates creating an app 120, such as creating an app 120 including app characteristics 122.

In the depicted product system 100, the default program prompt 124 further includes a second prompt 144 including information on a persona which the large language model 126 shall use. By way of example, the second prompt 144 includes a set of instructions, guidelines, and/or contextual information in form of the persona which the large language model 126 shall use. Herein, the information on the persona may include the information on the persona itself, the persona domain, and/or the persona experience level. Herein, the information on the persona may tell the LLM 126 which role to take and, e.g., which experience level to use as a basis in order to put the received user input 134 in the right context and, e.g., to create the app 120 as to match the user's intent as well as possible.

The respective app characteristic 122 may then be determined using the default program prompt 124 including the first prompt 128 and the second prompt 144 as well as the received user input 134 and the large language model 126. Further, the app 120 may then be developed and created using the app development platform 118 and the respective app characteristic 122.

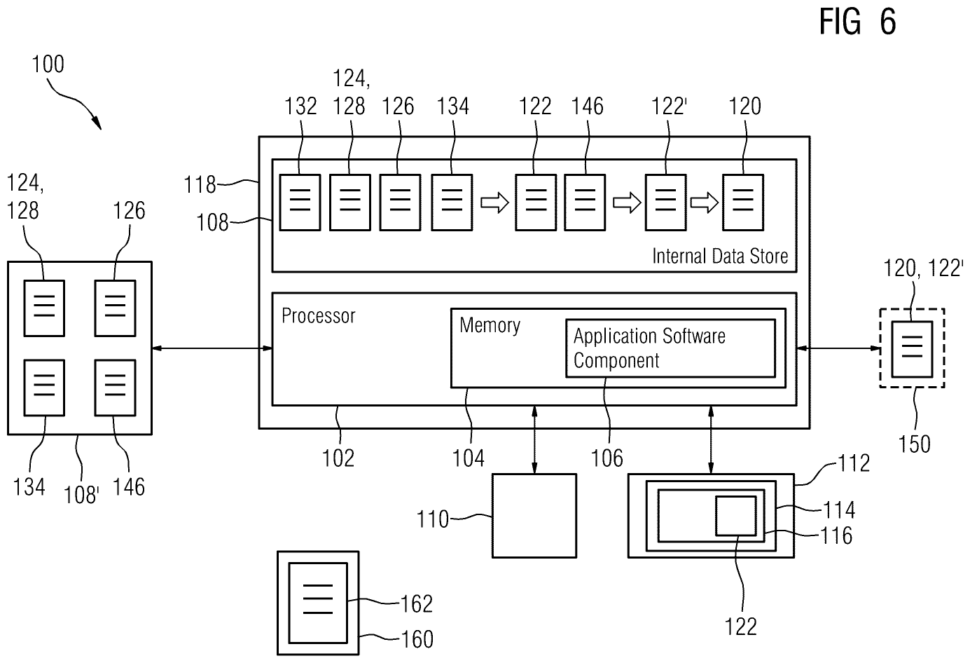

FIG. 6 depicts a functional block diagram of another example product system 100 that facilitates creating an app 120, such as creating an app 120 including app characteristics 122.

In the depicted product system 100, the respective app characteristic 122 may be determined using the default program prompt 124 including the first prompt 128 (and optionally the second prompt 144) as well as the received user input 134 and the large language model 126. The respective determined app characteristic 122 may then be displayed to the user via the app development UI 116. The user may then provide further user input 146 indicative of an amendment to the respective app characteristic 122 via the app development UI 116, wherein the further user input 146 is received by the app development platform 118. The app development platform 118 may then determine a respective amended app characteristic 122′ using the further user input 146, wherein further the default program prompt 124 and the large language model 126 are used and optionally the user input 134 received at an earlier stage.

Optionally, the respective amended app characteristic 122′ may also be displayed to the user via the app development UI 116 to allow for further iterations of user input indicative of further desired amendments to the respective app characteristic 122.

The app 120 may then be developed and created using the app development platform 118 and the respective amended app characteristic 122′.

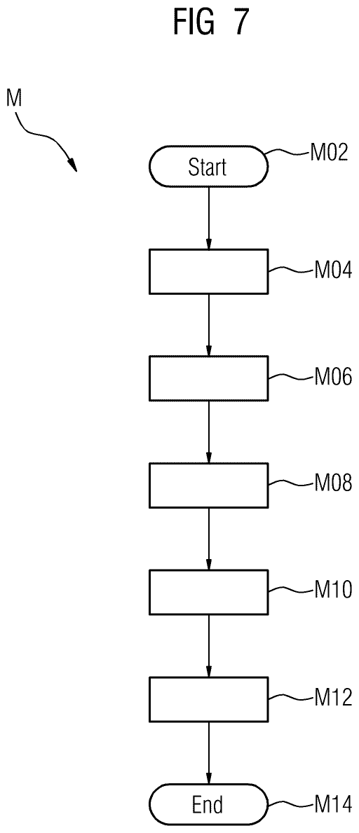

FIG. 7 depicts a flow diagram of a third example methodology M that facilitates creating an app, such as creating an app including app characteristics, in a product system. The method may start at M02, and the methodology may include several acts carried out through operation of at least one processor.

These acts may include an act M04 of providing an app development UI of an app development platform to a user for developing the app; an act M06 of providing a default program prompt associated with a large language model, wherein the default program prompt includes a first prompt to generate one or more function calls relating to default app characteristics matching received user input; an act M08 of receiving natural language user input indicative of at least one app characteristic of the app; an act M10 of determining the respective app characteristic using the default program prompt, the received user input and the large language model; and an act M12 of developing the app using the respective determined app characteristic. At M14 the methodology may end.

The methodology M may include other acts and features discussed previously with respect to the computer-implemented method of creating an app, such as creating an app including app characteristics, in a product system.

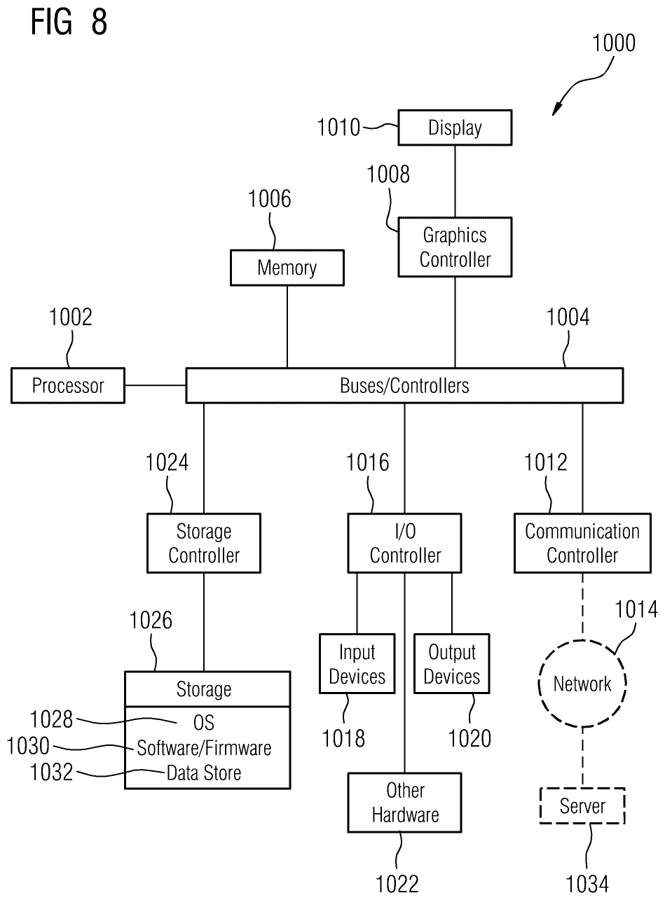

FIG. 8 depicts a block diagram of a data processing system 1000 (also referred to as a computer system) in which an embodiment may be implemented, for example, as a portion of a product system, and/or other system operatively configured by software or otherwise to perform the processes as described herein. The data processing system 1000 may include the computer or IT system or data processing system 100 mentioned above. The data processing system depicted includes at least one processor 1002 (e.g., a CPU) that may be connected to one or more bridges/controllers/buses 1004 (e.g., a north bridge, a south bridge). One of the buses 1004, for example, may include one or more I/O buses such as a PCI Express bus. Also connected to various buses in the depicted example may include a main memory 1006 (RAM) and a graphics controller 1008. The graphics controller 1008 may be connected to one or more display devices 1010. In some embodiments, one or more controllers (e.g., graphics, south bridge) may be integrated with the CPU (on the same chip or die). Examples of CPU architectures include IA-32, x86-64, and ARM processor architectures.

Other peripherals connected to one or more buses may include communication controllers 1012 (Ethernet controllers, WiFi controllers, cellular controllers) operative to connect to a local area network (LAN), Wide Area Network (WAN), a cellular network, and/or other wired or wireless networks 1014 or communication equipment.

Further components connected to various busses may include one or more I/O controllers 1016 such as USB controllers, Bluetooth controllers, and/or dedicated audio controllers (connected to speakers and/or microphones). Various peripherals may be connected to the I/O controller(s) (via various ports and connections) including input devices 1018 (e.g., keyboard, mouse, pointer, touch screen, touch pad, drawing tablet, trackball, buttons, keypad, game controller, gamepad, camera, microphone, scanners, motion sensing devices that capture motion gestures), output devices 1020 (e.g., printers, speakers) or any other type of device that is operative to provide inputs to or receive outputs from the data processing system. Also, certain devices referred to as input devices or output devices may both provide inputs and receive outputs of communications with the data processing system. For example, the processor 1002 may be integrated into a housing (such as a tablet) that includes a touch screen that serves as both an input and display device. Further, certain input devices (such as a laptop) may include a plurality of different types of input devices (e.g., touch screen, touch pad, keyboard). Also, other peripheral hardware 1022 connected to the I/O controllers 1016 may include any type of device, machine, or component that is configured to communicate with a data processing system.

Additional components connected to various busses may include one or more storage controllers 1024 (e.g., SATA). A storage controller may be connected to a storage device 1026 such as one or more storage drives and/or any associated removable media, which may be any suitable non-transitory machine usable or machine-readable storage medium. Examples include nonvolatile devices, volatile devices, read only devices, writable devices, ROMs, EPROMs, magnetic tape storage, floppy disk drives, hard disk drives, solid-state drives (SSDs), flash memory, optical disk drives (CDs, DVDs, Blu-ray), and other known optical, electrical, or magnetic storage devices drives and/or computer media. Also, in some examples, a storage device such as an SSD may be connected directly to an I/O bus 1004 such as a PCI Express bus.

A data processing system in accordance with an embodiment of the present disclosure may include an operating system 1028, software/firmware 1030, and data stores 1032 (that may be stored on a storage device 1026 and/or the memory 1006). Such an operating system may employ a command line interface (CLI) shell and/or a graphical user interface (GUI) shell. The GUI shell permits multiple display windows to be presented in the graphical user interface simultaneously, with each display window providing an interface to a different application or to a different instance of the same application. A cursor or pointer in the graphical user interface may be manipulated by a user through a pointing device such as a mouse or touch screen. The position of the cursor/pointer may be changed and/or an event, such as clicking a mouse button or touching a touch screen, may be generated to actuate a desired response. Examples of operating systems that may be used in a data processing system may include Microsoft Windows™, Linux™, UNIX™, iOS™, and Android™ operating systems. Also, examples of data stores include data files, data tables, relational database (e.g., Oracle™, Microsoft™ SQL Server), database servers, or any other structure and/or device that is capable of storing data, which is retrievable by a processor.

The communication controllers 1012 may be connected to the network 1014 (not a part of data processing system 1000), which may be any public or private data processing system network or combination of networks, as known to those of skill in the art, including the Internet. Data processing system 1000 may communicate over the network 1014 with one or more other data processing systems such as a server 1034 (also not part of the data processing system 1000). However, an alternative data processing system may correspond to a plurality of data processing systems implemented as part of a distributed system in which processors associated with several data processing systems may be in communication by way of one or more network connections and may collectively perform tasks described as being performed by a single data processing system. Thus, it is to be understood that when referring to a data processing system, such a system may be implemented across several data processing systems organized in a distributed system in communication with each other via a network.

Further, the term “controller” means any device, system, or part thereof that controls at least one operation, whether such a device is implemented in hardware, firmware, software, or some combination of at least two of the same. The functionality associated with any particular controller may be centralized or distributed, whether locally or remotely.

In addition, data processing systems may be implemented as virtual machines in a virtual machine architecture or cloud environment. For example, the processor 1002 and associated components may correspond to a virtual machine executing in a virtual machine environment of one or more servers. Examples of virtual machine architectures include VMware ESCi, Microsoft Hyper-V, Xen, and KVM.

Those of ordinary skill in the art will appreciate that the hardware depicted for the data processing system may vary for particular implementations. For example, the data processing system 1000 in this example may correspond to a computer, workstation, server, PC, notebook computer, tablet, mobile phone, and/or any other type of apparatus/system that is operative to process data and carry out functionality and features described herein associated with the operation of a data processing system, computer, processor, and/or a controller discussed herein. The depicted example is provided for the purpose of explanation only and is not meant to imply architectural limitations with respect to the present disclosure.

Also, the processor described herein may be located in a server that is remote from the display and input devices described herein. In such an example, the described display device and input device may be included in a client device that communicates with the server (and/or a virtual machine executing on the server) through a wired or wireless network (which may include the Internet). In some embodiments, such a client device, for example, may execute a remote desktop application or may correspond to a portal device that carries out a remote desktop protocol with the server in order to send inputs from an input device to the server and receive visual information from the server to display through a display device. Examples of such remote desktop protocols include Teradici's PCoIP, Microsoft's RDP, and the RFB protocol. In such examples, the processor described herein may correspond to a virtual processor of a virtual machine executing in a physical processor of the server.

As used herein, the terms “component” and “system” are intended to encompass hardware, software, or a combination of hardware and software. Thus, for example, a system or component may be a process, a process executing on a processor, or a processor. Additionally, a component or system may be localized on a single device or distributed across several devices.

Also, as used herein a processor corresponds to any electronic device that is configured via hardware circuits, software, and/or firmware to process data. For example, processors described herein may correspond to one or more (or a combination) of a microprocessor, CPU, FPGA, ASIC, or any other integrated circuit (IC) or other type of circuit that is capable of processing data in a data processing system, which may have the form of a controller board, computer, server, mobile phone, and/or any other type of electronic device.

Those skilled in the art will recognize that, for simplicity and clarity, the full structure and operation of all data processing systems suitable for use with the present disclosure is not being depicted or described herein. Instead, only so much of a data processing system as is unique to the present disclosure or necessary for an understanding of the present disclosure is depicted and described. The remainder of the construction and operation of data processing system 1000 may conform to any of the various current implementations and practices known in the art.

Also, the words or phrases used herein may be construed broadly, unless expressly limited in some examples. For example, the terms “comprise” and “comprise,” as well as derivatives thereof, mean inclusion without limitation. The singular forms “a,” “an,” and “the” are intended to include the plural forms as well, unless the context clearly indicates otherwise. Further, the term “and/or” as used herein refers to and encompasses any and all possible combinations of one or more of the associated listed items. The term “or” is inclusive, meaning and/or, unless the context clearly indicates otherwise. The phrases “associated with” and “associated therewith,” as well as derivatives thereof, may mean to comprise, be comprised within, interconnect with, contain, be contained within, connect to or with, couple to or with, be communicable with, cooperate with, interleave, juxtapose, be proximate to, be bound to or with, have, have a property of, or the like.

Also, although the terms “first,” “second,” “third,” and so forth may be used herein to describe various elements, functions, or acts, these elements, functions, or acts may not be limited by these terms. These numeral adjectives are used to distinguish different elements, functions or acts from each other. For example, a first element, function, or act may be termed a second element, function, or act, and, similarly, a second element, function, or act may be termed a first element, function, or act, without departing from the scope of the present disclosure.

In addition, phrases such as “processor is configured to” carry out one or more functions or processes, may mean the processor is operatively configured to or operably configured to carry out the functions or processes via software, firmware, and/or wired circuits. For example, a processor that is configured to carry out a function/process may correspond to a processor that is executing the software/firmware, which is programmed to cause the processor to carry out the function/process and/or may correspond to a processor that has the software/firmware in a memory or storage device that is available to be executed by the processor to carry out the function/process. A processor “configured to” carry out one or more functions or processes may also correspond to a processor circuit particularly fabricated or “wired” to carry out the functions or processes (e.g., an ASIC or FPGA design). Further, the phrase “at least one” before an element (e.g., a processor) that is configured to carry out more than one function may correspond to one or more elements (e.g., processors) that each carry out the functions and may also correspond to two or more of the elements (e.g., processors) that respectively carry out different ones of the one or more different functions.

In addition, the term “adjacent to” may mean that an element is near to but not in contact with a further element, or that the element is in contact with the further portion, unless the context clearly indicates otherwise.

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present patent document may be read as implying that any particular element, step, act, or function is an essential element, which must be included in the claim scope: the scope of patented subject matter is defined only by the allowed claims.

It is to be understood that the elements and features recited in the appended claims may be combined in different ways to produce new claims that likewise fall within the scope of the present disclosure. Thus, whereas the dependent claims appended below depend on only a single independent or dependent claim, it is to be understood that these dependent claims may, alternatively, be made to depend in the alternative from any preceding or following claim, whether independent or dependent, and that such new combinations are to be understood as forming a part of the present specification.

While the present disclosure has been described above by reference to various embodiments, it may be understood that many changes and modifications may be made to the described embodiments. It is therefore intended that the foregoing description be regarded as illustrative rather than limiting, and that it be understood that all equivalents and/or combinations of embodiments are intended to be included in this description.

1. A computer-implemented method of creating an app comprising app characteristics, the method comprising:
providing an app development user interface (UI) of an app development platform to a user for developing the app;
providing a default program prompt associated with a large language model, wherein the default program prompt comprises a first prompt to generate one or more function calls relating to default app characteristics matching received user input;
receiving natural language user input indicative of at least one app characteristic of the app;
determining the respective app characteristic using the default program prompt, the received user input, and the large language model; and
developing the app using the respective determined app characteristic.

2. The computer-implemented method of claim 1, wherein the determined respective app characteristic comprises a respective graph, and
wherein the respective graph comprises a plurality of entities associated with the respective app characteristic.

3. The computer-implemented method of claim 1, wherein the respective default app characteristic comprises a default model, a default rule, a default workflow, a default logic, a default functionality, a default user interface, a default application programming interface (API), a default target operation environment of a default app, or any combination thereof, and/or
wherein the respective app characteristic comprises a model, a rule, a workflow, a logic, a function, a user interface, an API, a functionality, a target operation environment of the app, or any combination thereof.

4. The computer-implemented method of claim 1, wherein the respective function call initiates creating the respective app characteristic matching the received user input and at least one of the default app characteristics.

5. The computer-implemented method of claim 1, wherein the respective app characteristic is associated with model-based app development.

6. The computer-implemented method of claim 1, wherein the default program prompt further comprises a second prompt having information on a persona for use by the large language model.

7. The computer-implemented method of claim 6, wherein the default program prompt further comprises information on a data format of the determined respective app characteristic, and
wherein the data format is a machine-parsable and/or graph description language format.

8. The computer-implemented method of claim 7, further comprising:
displaying the determined respective app characteristic in the data format via the app development UI; and
developing, by the app development platform, the app using the determined respective app characteristic in the data format.

9. The computer-implemented method of claim 1, wherein the default program prompt further comprises information on a data format of the determined respective app characteristic, and
wherein the data format is a machine-parsable and/or graph description language format.

10. The computer-implemented method of claim 9, further comprising:
displaying the determined respective app characteristic in the data format via the app development UI; and
developing, by the app development platform, the app using the determined respective app characteristic in the data format.

11. The computer-implemented method of claim 10, further comprising:
displaying the respective app characteristic to the user via the app development UI;
receiving further user input indicative of an amendment to the respective app characteristic via the app development UI; and
determining a respective amended app characteristic using the further user input.

12. The computer-implemented method of claim 11, further comprising:
deploying the app on a target device.

13. The computer-implemented method of claim 1, wherein the large language model is trained with other app characteristics of other apps, wherein the other apps are optionally developed with model-based app development.

14. The computer-implemented method of claim 1, further comprising:
displaying the respective app characteristic to the user via the app development UI;
receiving further user input indicative of an amendment to the respective app characteristic via the app development UI; and
determining a respective amended app characteristic using the further user input.

15. The computer-implemented method of claim 1, further comprising:
deploying the app on a target device.

16. A computer system comprising:
at least one memory; and
at least one processor configured, in combination with the at least one memory, to cause the computer system to:
provide an app development user interface (UI) of an app development platform to a user for developing an app;
provide a default program prompt associated with a large language model, wherein the default program prompt comprises a first prompt to generate one or more function calls relating to default app characteristics matching received user input;
receive natural language user input indicative of at least one app characteristic of the app;
determine the respective app characteristic using the default program prompt, the received user input, and the large language model; and
develop the app using the respective determined app characteristic.

17. A computer program product or a computer-readable medium comprising the computer program product, wherein the computer program product comprises computer program code that, when executed by a computer system, causes the computer system to:
provide an app development user interface (UI) of an app development platform to a user for developing an app;
provide a default program prompt associated with a large language model, wherein the default program prompt comprises a first prompt to generate one or more function calls relating to default app characteristics matching received user input;
receive natural language user input indicative of at least one app characteristic of the app;
determine the respective app characteristic using the default program prompt, the received user input, and the large language model; and
develop the app using the respective determined app characteristic.
